(19) United States
(12) Patent Application Publication
(10) Pub. No.: US 2017/0284083 A1
(43) Pub. Date: Oct. 5, 2017

(54) COILED PRECOMPRESSED, PRECOATED JOINT SEAL AND METHOD OF MAKING

(71) Applicant: Emseal Joint Systems Ltd., Westborough, MA (US)

(72) Inventors: Lester Hensley, Westborough, MA (US); William Witherspoon, Guelph (CA)

(73) Assignee: Emseal Joint Systems Ltd., Westborough, MA (US)

(21) Appl. No.: 15/494,069

(22) Filed: Apr. 21, 2017

Related U.S. Application Data
(63) Continuation-in-part of application No. 14/084,930, filed on Nov. 20, 2013, now abandoned.
Application No. 14/084,930 is a continuation-in-part of application No. 13/729,500, filed on Dec. 28, 2012, now Pat. No. 9,670,666.
Application No. 13/729,500 is a continuation-in-part of application No. 12/622,574, filed on Nov. 20, 2009, now Pat. No. 8,365,495.
Application No. 12/622,574 is a continuation-in-part of application No. 13/731,327, filed on Dec. 31, 2012, now Pat. No. 9,637,915.
Application No. 13/731,327 is a continuation-in-part of application No. 12/635,062, filed on Dec. 10, 2009, now Pat. No. 9,200,437.
(60) Provisional application No. 61/729,040, filed on Nov. 21, 2012.
(60) Provisional application No. 61/116,453, filed on Nov. 20, 2008.
(60) Provisional application No. 61/121,590, filed on Dec. 11, 2008.

(51) Int. Cl. E04B 1/68; F16J 15/02; E04C 2/20; B29C 43/02; E04B 1/94

(52) U.S. Cl. CPC E04B 1/6812; B29C 43/02; E04B 1/948; E04B 1/6806; E04C 2/205; F16J 15/022; E04B 1/944

(57) ABSTRACT

Disclosed is a water resistant joint sealing system comprising a coiled, coated precompressed core material. In one embodiment, the joint sealing system includes a fire retardant material put into the core material. In one embodiment, the fire retardant material forms a layer in, or between portions of material of, the core material.

### CROSS REFERENCE TO RELATED APPLICATIONS

This application is a Continuation-in-Part Application of U.S. patent application Ser. No. 14/084,930 (Attorney Docket No. 1269-0007-1), filed on Nov. 20, 2013, which claims the benefit of U.S. Provisional Patent Application No. 61/729,040, filed on Nov. 21, 2012, the contents of each of which are incorporated herein by reference in their entirety and the benefits of which are fully claimed herein. This application also is a Continuation-in-Part Application of U.S. patent application Ser. No. 13/729,500 (Attorney Docket No. 1269-0001-1CIP), filed on Dec. 28, 2012, which is a Continuation-in-Part Application of U.S. patent application Ser. No. 12/622,574, filed on Nov. 20, 2009, now U.S. Pat. No. 8,365,495, which claims the benefit of U.S. Provisional Patent Application No. 61/116,453, filed on Nov. 20, 2008, the contents of each of which are incorporated herein by reference in their entireties and the benefits of each are fully claimed. This application also is a Continuation-in-Part Application of U.S. patent application Ser. No. 13/731,327 (Attorney Docket No. 1269-0002-1CIP), filed on Dec. 31, 2012, which is a Continuation-in-Part Application of U.S. patent application Ser. No. 12/635,062 (Attorney Docket No. 1269-0002-1), filed on Dec. 10, 2009, now U.S. Pat. No. 9,200,437, which claims the benefit of U.S. Provisional Patent Application No. 61/121,590, filed on Dec. 11, 2008, the contents of each of which are incorporated herein by reference in their entireties and the benefits of each are fully claimed.

### TECHNICAL FIELD

The present disclosure relates generally to joint sealing systems. More particularly, the present disclosure relates to expansion joint sealing systems configured for installation in joints between substrates including, for example, concrete and other building or structural systems requiring thermal, wind and/or seismic expansion joints to accommodate building or other structural movements. The present disclosure also applies to many other joints, which do not experience large movements, but still are required to resist water ingress, and provide thermal and other characteristics. These joints include, for example, masonry control joints, facade joints, window perimeter joints, precast concrete joints, metal panel joints, and others.

### BACKGROUND

Most commercial and industrial buildings contain expansion joints, control joints, and other gaps either by design or not. Expansion joints primarily allow for thermal expansion and contraction, and additionally it is desirable to allow for wind generated movements and seismically generated movements of the building structure. Control joints are used to allow for concrete shrinkage during curing, eliminating tensile forces across the joint thus preventing cracking of the concrete. Window perimeter joints exist to accommodate and allow for inaccuracies in building construction, and to prevent any forces from transferring to the windows themselves. References to building joints below should be understood to be any of a variety of these structures.

In the case of exterior joints, the joint sealing system should, to some degree, seal the joint from and/or resist the effects of the external environment conditions. As such, most external expansion joint sealing systems are designed to resist the effects of water. In vertical joints this will typically be in the form of rain, and wind driven rain. In horizontal joints, this will typically be in the form of rain, standing water, snow, ice, and in some circumstances all of these at the same time.

Water resistant or water tight sealing joints can exist in different forms, but generally are constructed from materials designed to resist water penetration and to accommodate the physical cycling caused by the building's thermal, wind, and seismic movement.

Devices have been used to attempt to create water tight expansion joints sealing systems. One such sealing system, known as “caulk and backer rod” requires on-site assembly by a skilled applicator to create a finished functional expansion joint system. These systems can suffer from numerous deficiencies, related both to the installation method and the technology itself. Installation problems include difficulty in inserting the backer rod, and difficulty setting the appropriate depth of the backer rod. Technological problems include closed cell compression set of the backer rod, potentially poor or no adhesion between backer rod and top coated caulk, caulk in tension, caulk curing in ambient or less than ideal conditions, and caulk curing while movement is occurring in place. Additionally, these problems are typically exacerbated if the movement joints are nominally larger than about 1 inch in width across the joint, or movements are larger than about +/−10-15%.

Such afore-described factors can lead to less than desirable results, such as short life span, low movement capability, and ultimately water ingress and attendant issues thereof. The onsite assembly nature of caulk and backer rod systems can cause installation labor costs to be high, offsetting much of the perceived cost benefits of the cheaper components.

U.S. Pat. No. 5,130,176 by Baerveldt, describes a system which addresses some of these problems. The sealant system Baerveldt describes can eliminate the need for onsite assembly, and improve productivity. Baerveldt's device is particularly effective in joints larger than about 1.5 inches in width, and can, e.g., be used in joint as large as about 12 inches in width across the joint. However, while it is effective in joints smaller than about 1.5 inches, the cost of the device as compared to the caulk and backer rod system can be disproportionate and it is typically not used in these scenarios despite the technological advantages it offers.

A trend in the building industry is towards fewer, and larger expansions joints. This is occurring, in part, because expansion joints are typically sited as points of failure for water penetration. Additionally, it is due to building codes mandating that larger seismic movements be taken into consideration during design. However, there still remains a need in the industry for smaller sized joints, which also can be difficult to address.

Thus, there remains a need for further structures and expansion joint sealing systems for preventing water ingress, providing thermal and other desirable characteristics, while also accommodating structural movements. There also is a need for such structures effective in joint sizes less than or equal to about 1.5 inches in width across the joint.

### SUMMARY

Accordingly, provided herein according to embodiments are structures and methods that prevent water ingress, provide thermal and other desirable characteristics, while accommodating structural movements and sealing a joint, among providing other advantages. Embodiments disclosed herein overcome the technological problems of previous building joint seal designs, such as caulk and backer rod, and improve upon the teachings of Baerveldt, while remaining cost competitive in smaller joint sizes. Embodiments disclosed herein also are particularly suitable for use in smaller joint sizes, such as joints having a width less than or equal to about 2 inches, including less than or equal to about 1.5 inches, as well as less than or equal to about 1 inch in width across the joint.

According to an aspect, disclosed herein is a joint seal system product comprising a coiled precompressed impregnated self expanding core material coated with an integral elastomer coating pre-formed into an arched shape transverse to the direction of compression. The core material is made of a suitable material, such as foam, and is generally rectilinear in shape, while the elastomer coating forms an arch. The core material is supplied precompressed and is self expanding upon release of the packaging. The core material is compressed transverse to the elastomer arch acting to reduce the radius of the arch.

Accordingly to further aspects, methods of producing the afore-referenced product are included herein. Thus, in an embodiment, a method of making a water resistant precompressed joint seal system comprises coating a core material with a water resistant elastomer to form a coated sheet; cutting the coated sheet into a strip; forming the strip into an arched profile; and compressing the arched strip.

An advantage of embodiments of the present invention is that the core material and elastomer arch can expand and be compressed transversely.

Another advantage of embodiments of the present invention is that it is inexpensive, and may be easily installed by one individual. It is a further advantage of embodiments of the present invention that the resultant product can be supplied in a precompressed coil, wherein the coil, the shape and compression is retained.

Moreover, embodiments are weather resistant, conform to the substrates within which the product is installed and can remain substantially permanently resilient. The product is delivered in a coiled pre-compressed state ready for installation into the building joint, and no on-site construction or assembly of the product is required, according to embodiments.

### BRIEF DESCRIPTION OF THE DRAWINGS

Referring now to the Figures, which are exemplary embodiments, and wherein like elements are numbered alike:

FIG. 1A is a schematic sectional view of precoated joint seal system in strip form;

FIG. 1B is a schematic view of the seal system of FIG. 1 after compressing and arching;

FIG. 2 is a schematic illustration of the compressed and arched strip of FIG. 1B wound onto a spool;

FIG. 2A is a sectional view of FIG. 2 taken along Section A-A of FIG. 2;

FIG. 3 schematically illustrates the compressed and arched strip of FIG. 1B installed between substantially coplanar substrates; and

FIG. 4 schematically illustrates a compressed and arch strip wound onto a spool and including a second coating of an elastomer on the bottom of the core material, according to an embodiment;

FIG. 4A is a sectional view of FIG. 4 taken along Section A-A of FIG. 4;

FIG. 5 is a schematic view of another embodiment of the precoated joint seal system; and

FIG. 6 is a schematic view of still another embodiment of the precoated joint seal system.

### DETAILED DESCRIPTION

Embodiments of the present invention relate to a resilient water resistant joint seal system able to accommodate thermal, seismic, and other building or structural movements, if necessary, while maintaining its water resistance and other desirable characteristics. Although other methods and materials may be used in the constructions described herein, particularly suitable and preferred methods and materials are described herein. Unless stated otherwise, any technical or scientific terms used will have the meaning as understood by one of ordinary skill in the art to which the present invention pertains.

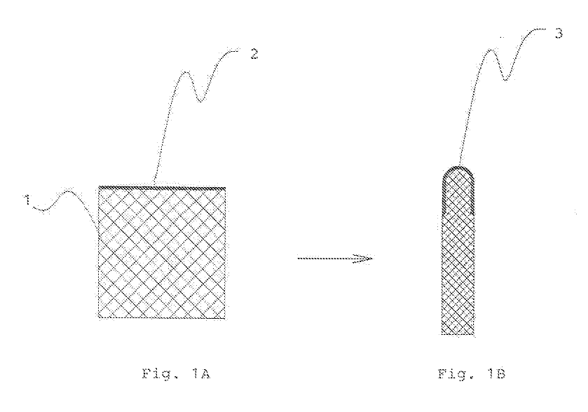

The expansion joint systems described herein according to embodiments are best understood by referring to the attached drawings. Referring to FIG. 1A, disclosed therein is a section view of the first embodiment of the present invention. In this first embodiment, the core material comprises strips of open celled polyurethane foam 1 that have been impregnated with a water resistant chemistry. The strips are fabricated from larger sheets that are typically about 1.5 inches thick by 20 inches wide by 10 feet in length. Other dimensions can be used according to the situation as required. The foam sheets are preferentially impregnated with a suitable water resistant chemistry, such as a water based acrylic. After the impregnation media has been appropriately cured, the sheet is coated with a suitable water resistant or water proof material 2 such as an elastomer or the like such as, for example, Dow 790 silicone. The coating is applied to a thickness of approximately 0.032 inches or about 1 mm. This layer is cured per the manufacturer's directions. It should be appreciated that while described, in one embodiment, as a silicone coating, it is within the scope of the present invention to employ, according to embodiments, any suitable water resistant or water proof coating, layer or the like, on a surface or within the core material, to enhance water resistance or water proofing characteristics of the embodiments. In some embodiment, this water resistant or water proof material 2 may be a polysulfide, silicone, acrylic, polyurethane, poly-epoxide, silyl-terminated polyurethane, silyl-terminated polyether, a formulation of one or more of the foregoing materials with or without other elastomeric components or similar suitable elastomeric coating or liquid sealant materials, or a mixture, blend, or other formulation of one or more of the foregoing. One preferred elastomer coating for application to a horizontal deck where vehicular traffic is expected is Pecora 301, which is a silicone pavement sealant available from Pecora Corporation of Harleysville, Pa. Another preferred elastomeric coating is Dow Corning 888, which is a silicone joint sealant available from Dow Corning Corporation of Midland, Mich. Both of the foregoing elastomers are traffic grade rated sealants. For vertically-oriented expansion joints, exemplary preferred elastomer coatings include Pecora 890, Dow Corning 790, and Dow Corning 795.

Depending on the nature of the adhesive characteristics of the water resistant or water proof material 2, a primer may be applied to the outer surfaces of the core material 1 prior to the coating with the material 2. Applying such a primer may facilitate the adhesion of the material 2 to the core 1.

The sheet is then slit into strips appropriate to the width of the expansion joint employed. The resulting strip is typically rectilinear in shape, and has at least one surface coated with an elastomer, such as elastomer 2. After slitting, the strip is manually or mechanically compressed transversely. At the same time, the elastomer 2 can be formed into an arch, dome or like shape 3, as shown in FIG. 1B. The arched or dome elastomer profile is advantageous in the design. For example, other products may exist in the art, but do not contain the precompressed self-expanding arched element, with the arch being transverse to the direction of compression. The precompressed arched shape acts as an elastomeric spring, creating compressive forces against the substrate effecting a water tight seal. In the case of moving expansion joints, the compressive force of the arched elastomer and underlying foam, allows the product to maintain a weather tight seal throughout the movement regime of the joint.

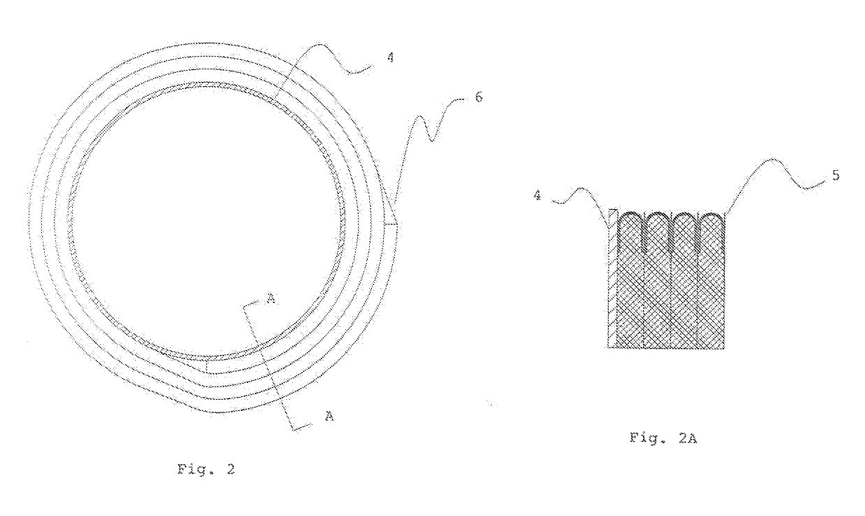

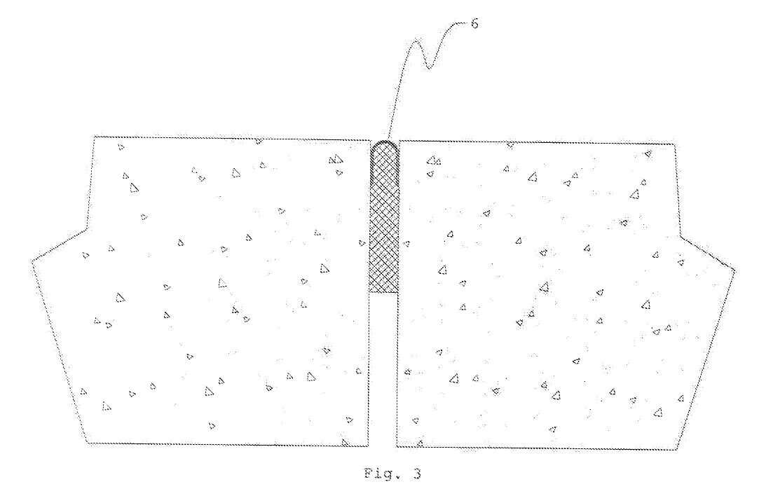

Referring now to FIG. 2, after compression and shaping, the material is wound onto a spool 4 made of suitable material, such as cardboard, and so forth. It is noted that while spool 4 is primarily referred to herein, other suitable substrates and/or devices could be employed in place of spool 4 to hold and/or contain the material, such as an open or solid rod, and so forth. The compression and shape can be maintained by using a relatively inextensible plastic liner 5, as schematically shown in FIG. 2A, or other suitable material for the liner. The plastic liner 5 also can include a pressure sensitive adhesive which is wound against the foam. This pressure sensitive adhesive can be used as an installation aid. As the compressed foam is wound around the core, depending on the length, it will overlap itself multiple times. The liner keeps each wrap discrete, and prevents adhesion between the layers. At the conclusion of the process the liner is secured to itself by means of adhesive tape. It is advantageous that an inexpensive plastic liner can be used to maintain the compressed shape and size of the product in the form of a coil, as previous design testing iterations required more expensive packaging options to maintain the desired shape and level of compression.

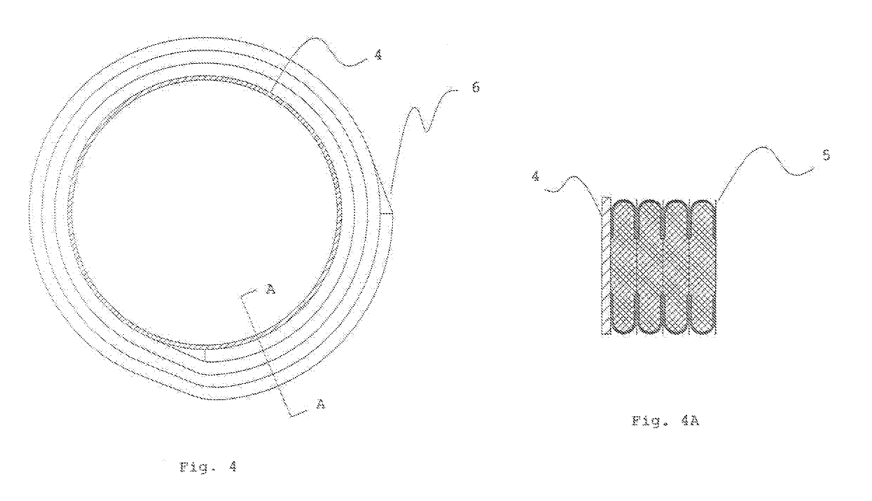

In a typical installation, the product can be installed into a joint on site by cutting the liner at a desired location, such as location 6, as shown in FIGS. 2 and 4, releasing pressure on the foam, which begins to expand. The installer inserts the product, which is received at smaller than joint size, into the joint at the same time stripping the liner from the product. Removing the liner exposes the pressure sensitive adhesive on the side of the foam, which preferentially transfers from the liner. The installer positions the product at the appropriate depth, and presses the adhesive against the substrate, locking it in place. The arched elastomer and underlying foam expands to fill the joint, effectively completing the installation. FIG. 3 illustrates such an embodiment installed between concrete substrates. It is noted that the depth of the core shown in FIG. 3 is merely exemplary and other suitable depths could be employed, including but not limited to, extending the core all the way down, half way down, three-fourths down, and so forth, to the lower edge of the substantially coplanar substrates.

Another embodiment of this design, as shown in FIG. 4, includes a second coating of an elastomer on, e.g., the bottom of the core material, which can be similarly formed as described above. This creates a product that has a waterproof membrane on both interior and exterior surfaces.

A further embodiment of this design includes the use of a pick-proof elastomer coating, such as, for example, Pecora Dynaflex SC.

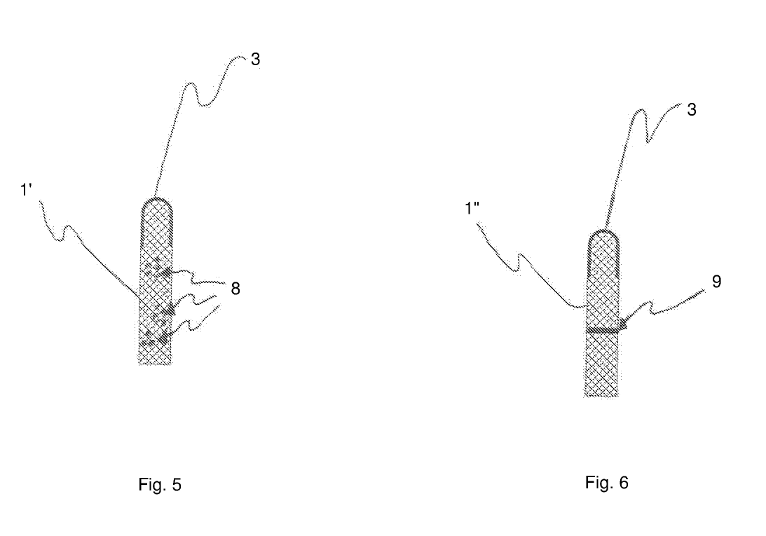

Still further, in all embodiments described herein and as illustrated in FIG. 5, an impregnation media 8, is infused, impregnated or otherwise put into or included in the foam/core material 1, whose primary characteristic is, e.g., that of a fire retardant, can be included in the design for additional benefits. The foam/core material 1 including the fire retardant material 8 is referred to as foam/core material 1′. One type of fire retardant material that may be used is a water-based aluminum tri-hydrate (also known as aluminum tri-hydroxide (ATH)). However, the present invention is not limited in this regard, as other fire retardant materials may be used. Such materials include, but are not limited to, metal oxides and other metal hydroxides, aluminum oxides, antimony oxides and hydroxides, graphite, iron compounds, such as ferrocene, molybdenum trioxide, nitrogen-based compounds, phosphorus based compounds, halogen based compounds, halogens, e.g., fluorine, chlorine, bromine, iodine, astatine, combinations of any of the foregoing materials, and other compounds capable of suppressing combustion and smoke formation.

In the embodiments described herein, the infused/impregnated foam and/or core material 1′ may be constructed in a manner which insures that the amount of fire retardant material 8 that is put into the foam/core 1 is such that the resultant material 1′ can pass Underwriters Laboratories' UL 2079 test program regardless of the final size of the product. For example, in accordance with various embodiments, the amount of fire retardant material 8 that is put into the foam/core 1 is such that the resultant material 1′ is capable of withstanding exposure to a temperature of about 540° C. at about five minutes, a temperature of about 930° C. at about one hour, a temperature of about 1010° C. at about two hours, or a temperature of about 1260° C. at about eight hours, without significant deformation in the integrity of, e.g. joint system. As a non-limiting example, the amount of fire retardant material 8 put into the foam/core 1, such as an open celled foam, is between 3.5:1 and 4:1 by weight in a ratio with the un-infused foam/core itself. The resultant uncompressed foam/core 1′ whether comprising a solid block or a plurality of laminates, can have a density in a range of about 130 kg/m³ to about 150 kg/m³, specifically 140 kg/m³, according to embodiments. Other suitable densities for the resultant uncompressed foam/core 1′ include densities in a range of between about 50 kg/m³ and about 250 kg/m³, e.g., more particularly, embodiments between about 80 kg/m³ and about 180 kg/m³, or about 100 kg/m³ and about 180 kg/m³, and which are capable of providing desired water resistance and/or waterproofing characteristics to the structure. According to embodiments, the infused foam and/or core 1′ may be constructed in a manner which insures that substantially the same density of fire retardant material 8 is present in the product regardless of the final size of the product. In one embodiment, the uncompressed density of the infused foam/core 1′ is approximately 140 kg/m³. The infused foam/core 1′ may typically cycle between densities in the range of about 160-800 kg/m³, according to embodiments. The present invention is not limited to cycling in the foregoing ranges. For example, depending on embodiments, installation and compression ratios, the foam/core 1′ may attain densities outside of the herein-described ranges of, e.g., about 160-800 kg/m³. Accordingly, in the embodiments described herein, the infused/impregnated foam and/or core 1′ may be constructed in a manner which insures that the amount of fire retardant material 8 that is put into the foam/core 1 is such that the resultant material 1′ can pass Underwriters Laboratories' UL 2079 test program regardless of the final size of the product.

Still further, in all embodiments described herein and as illustrated in FIG. 6, the fire retardant material 8 put into the foam/core 1 is in a form of a “sandwich type” construction wherein the fire retardant material 8 forms a layer 9 in, or between portions of material of, the foam/core 1. Thus, the layer 9 comprising the fire retardant material 8 can be located within the body of the foam/core 1 as, e.g., an inner layer, or lamination infused with a higher ratio or density of fire retardant material than the foam/core 1. The foam/core material 1 including the fire retardant material 8 in the “sandwich type” construction is referred to as foam/core material 1″. It is noted that the terms “infused,” “impregnated” and “put into” as used throughout the descriptions herein is meant to be broadly interpreted to refer to “includes” or “including.” Thus, for example, “a foam/core infused with a fire retardant” covers a “core including a fire retardant” in any form and amount, such as a layer, and so forth. Accordingly, as used herein, the term “infused” would also include, but not be limited to, more particular embodiments such as “permeated” or “filled with” and so forth.

Moreover, it is noted that layer 9 is not limited to an exact location within the foam/core 1″ shown in FIG. 6, as the layer 9 may be included at various depths in the foam/core 1″ as desired. It is further noted that the layer 9 may extend in any direction relative to the width of the joint. For example, the layer 9 may be oriented parallel to the direction in which the joint width extends, perpendicular to the direction in which the joint width extends, or combinations of the foregoing. Layer 9 can function as a fire resistant barrier layer within the body of the foam/core 1″. Accordingly, layer 9 can comprise any suitable material providing, e.g., fire barrier properties.

It is also noted that additional layers could be employed if desired in the embodiment of FIG. 6, as well as in the other embodiments disclosed herein, and in any suitable combination and order. Additionally, in any/all embodiments, a fire barrier sealant (such as 3M CP25-WB) could be employed at any desired location in the design, such as within the foam/core 1, as a coating, and so forth.

In operation, the arched elastomer, and the core's, e.g., foam's, expansion force creates a water tight seal against an appropriate substrate. In the case of a moving expansion joint, these forces allow the foam to follow the building's (substrate's) movements while maintaining contact with the substrates. It is further noted that foam, e.g., open celled foam merely illustrates one suitable material for the foam/core 1. Accordingly, examples of materials for the foam/core 1 include, but are not limited to, foam, e.g., polyurethane foam and/or polyether foam, and can be of an open cell or dense, closed cell construction. Further examples of materials for the foam/core 1 include paper based products, cardboard, metal, plastics, thermoplastics, dense closed cell foam including polyurethane and polyether open or closed cell foam, cross-linked foam, neoprene foam rubber, urethane, ethyl vinyl acetate (EVA), silicone, a core chemistry (e.g., foam chemistry) which inherently imparts hydrophobic and/or fire resistant characteristics to the foam/core 1; and/or composites. Combinations of any of the foregoing materials or other suitable material also can be employed. It is further noted that while foam is primarily referred to herein as a material for the core, the descriptions for foam also can apply to other materials for the core, as explained above.

Embodiments disclosed herein, particularly the afore-referenced design, address shortcomings of previous designs, solve problems associated with caulk and backer rod designs, and improve upon the teachings of Baerveldt in a cost efficient manner especially for small joints. Moreover, often expensive and wasteful packaging materials can be replaced with an inexpensive plastic liner, and inexpensive cardboard core. The coiled form greatly reduces other packaging materials as well, such as boxes, and skids. The coiled form also makes on site handling and installation much more efficient and simpler.

Further advantages include the ability to provide, e.g., a precompressed sealant in tape form.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims. Thus, various embodiments, including constructions, and so forth described herein and described in the afore-referenced priority applications, can be combined in any combination and in any order. Thus, the embodiments described herein are not limited to the particular constructions of the figures, as the various materials, elements and so forth described herein and described in the afore-referenced priority application can be combined in any desired combination, amount and order.

What is claimed is:

1. A water resistant precompressed joint system comprising:
a pre-compressed, coated core strip windable onto a device multiple times and including:
a top coat on said core strip of an elastomeric water proofing material formed into an arched, or a dome profile transverse to a direction of compression of the core strip against the device; and
a liner configured to hold the coated core strip in compression;
wherein the pre-compressed, coated core strip is wound onto the device so that the pre-compressed, coated core strip with the liner overlaps the pre-compressed, coated core with the liner multiple times creating discrete layers of wraps and the liner is positioned to keep each wrap discrete from a next wrap to prevent adhesion between the layers of the wraps.

2. The water resistant precompressed joint system of claim 1, wherein said top coat is formed mechanically or manually into the arched or dome shape.

3. The water resistant precompressed joint system of claim 2, wherein a bottom coat is formed mechanically or manually into a transverse arched or dome shape thereby creating a substantially symmetrical shape.

4. The water resistant precompressed joint system of claim 3, wherein the pre-compressed core strip further comprises impregnation of a fire retardant material into the core strip thereby forming a water and fire resistant expansion joint system.

5. The system of claim 4, wherein the top coat and/or the bottom coat is a fire barrier sealant.

6. The system of claim 4, wherein the core strip with the fire retardant material has a density in a range of about 160 kg/m³ to about 800 kg/m³; and the precompressed joint system is configured to pass testing mandated by UL 2079.

7. The system of claim 4, wherein the core comprises open celled foam.

8. The system of claim 7, wherein the device is a spool.

9. A water and fire resistant expansion joint system comprising:
a pre-compressed, coated foam strip windable onto a device multiple times and including:
a top coat on said foam strip of a water resistant material transverse to a direction of compression of the foam strip against the device;
a fire retardant infused into the foam strip; and
a liner configured to hold the coated foam strip in compression;
wherein the pre-compressed, coated foam strip is wound onto the device so that the pre-compressed, coated foam strip with the liner overlaps itself multiple times creating discrete layers of wraps and the liner is positioned to keep each wrap discrete from a next wrap to prevent adhesion between the layers of the wraps; and
wherein the foam strip with the fire retardant has as a density in a range of about 160 kg/m³ to about 800 kg/m³; and the water and fire resistant expansion joint system is configured to pass testing mandated by UL 2079.

10. The water and fire resistant expansion joint system of claim 9, wherein the device is a spool.

11. A method of making a water resistant precompressed joint system comprising:
coating a core material with a water resistant elastomer to form a coated sheet;
cutting the coated sheet into a strip;
forming the strip into an arched profile; and
compressing the arched strip.
